(19) United States
(12) Patent Application Publication
(10) Pub. No.: US 2016/0012402 A1
(43) Pub. Date: Jan. 14, 2016

(54) SYSTEMS AND METHODS FOR AUTOMATICALLY COLLECTING PAYMENT

(71) Applicant: InstaMed, LLC, Philadelphia, PA (US)

(72) Inventors: Jon Neal, Pittstown, NJ (US); Steve Pidhirsky, Phoenixville, PA (US)

(21) Appl. No.: 14/328,034

(22) Filed: Jul. 10, 2014

(51) Int. Cl. G06Q 20/14; G06Q 50/22; G06Q 20/40

(52) U.S. Cl. CPC G06Q 20/14; G06Q 20/40; G06Q 50/22

(57) ABSTRACT

Systems and methods for automatically processing a payment for medical services rendered using a stored patient account. A system may include a processor and a non-transitory, processor-readable storage medium. The non-transitory, processor-readable storage medium may include one or more programming instructions that, when executed, cause the processor to receive a document having medical transaction information and demographic information from a medical service provider, parse the document to obtain the demographic information, determine that the demographic information corresponds to a stored patient account having a preauthorized payment account, and deduct an amount from the preauthorized payment account that corresponds to at least a portion of an amount due obtained from the medical transaction information.

### BACKGROUND

After medical services have been rendered to a patient, an uncertainty may exist as to what an insurance provider or other responsible party owes or will pay for the rendered services. Thus, a large volume of unpaid bills exists in the medical industry because patients may not pay the correct amount due at the time of service. For example, a patient may pay a co-pay at the time of service, but may leave the healthcare provider's premises before either the patient or the healthcare provider is aware that the patient's insurer will not pay for a certain service that was rendered. Thus, a bill must be sent to the patient to collect the unpaid funds.

Certain providers struggle to send these bills due to the large number of patients they see on a month-to-month basis. Certain solutions for unpaid bill collections have included keeping a patient's credit card “on file” such that an unpaid balance can be charged to the credit card. However, due to the large number of bills and the amount of time involved, it remains difficult for a provider to conduct a search for each patient account, determine if a credit card is “on file”, and charge the credit card accordingly.

### SUMMARY

In an embodiment, a system may include a processor and a non-transitory, processor-readable storage medium. The non-transitory, processor-readable storage medium may include one or more programming instructions that, when executed, cause the processor to receive a document having medical transaction information and demographic information from a medical service provider, parse the document to obtain the demographic information, determine that the demographic information corresponds to a stored patient account having a preauthorized payment account, and deduct an amount from the preauthorized payment account that corresponds to at least a portion of an amount due obtained from the medical transaction information.

In an embodiment, a method may include receiving, by a processor, a document having medical transaction information and demographic information from a medical service provider, parsing, by the processor, the document to obtain the demographic information, determining, by the processor, that the demographic information corresponds to a stored patient account having a preauthorized payment account, and deducting, by the processor, an amount from the preauthorized payment account that corresponds to at least a portion of an amount due obtained from the medical transaction information.

In an embodiment, a system may include a processor and a non-transitory, processor-readable storage medium. The non-transitory, processor-readable storage medium may include one or more programming instructions that, when executed, cause the processor to receive a document having medical transaction information and demographic information from a medical service provider, parse the document to obtain the demographic information, determine that the demographic information corresponds to a stored patient account not having a preauthorized payment account, and cause a statement to be sent to a payor associated with the stored patient account, wherein the statement comprises an amount that corresponds to at least a portion of an amount due obtained from the medical transaction information.

### BRIEF DESCRIPTION OF THE DRAWINGS

FIG. 1 depicts an illustrative diagram of a system for automatically collecting payment and/or updating demographic information according to an embodiment.

FIG. 2 depicts a flow diagram of an illustrative method of processing a statement file according to an embodiment.

FIG. 3 depicts a flow diagram of an illustrative method of processing a remittance according to an embodiment.

FIG. 4 depicts a flow diagram of an illustrative method of processing a demographic file according to an embodiment.

FIG. 5 depicts a block diagram of illustrative internal hardware that may be used to contain or implement program instructions, such as the process steps discussed herein, according to various embodiments.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

An “electronic device” refers to a device that includes a processor and a tangible, computer-readable memory or storage device. The memory may contain programming instructions that, when executed by the processor, cause the processor to perform one or more operations. Examples of electronic devices include personal computers, supercomputers, gaming systems, televisions, mobile devices, medical devices, recording devices, and/or the like.

A “mobile device” refers to an electronic device that is generally portable in size and nature, or is capable of being operated while in transport. Accordingly, a user may transport a mobile device with relative ease. Examples of mobile devices include pagers, cellular phones, feature phones, smartphones, personal digital assistants (PDAs), cameras, tablet computers, phone-tablet hybrid devices (“phablets”), laptop computers, netbooks, ultrabooks, global positioning satellite (GPS) navigation devices, in-dash automotive components, media players, watches, portable medical devices, and the like.

A “computing device” is an electronic device, such as a computer, a processor, a memory, and/or any other component, device, or system that performs one or more operations according to one or more programming instructions.

A “medical service provider” is, collectively or individually, a medical laboratory performing medical tests and evaluating medical samples, a hospital, a medical clinic, a primary care physician (PCP), a medical specialist such as, for example, a thoracic surgeon, a dermatologist, or a dentist, employees of the PCP, specialist, laboratory, hospital, or clinic, employees of the practice group to which the PCP or specialist belong, or any other similar or related entity. Typical employees may include, but are not limited to, nurses, interns, student doctors, resident doctors, physician's assistants, laboratory technicians, filing clerks, office managers, and receptionists.

A “preauthorized payment account” is any financial account that has been authorized for electronically sending and/or receiving funds. The preauthorized payment account is generally held and/or controlled by a payor entity responsible for making payments for medical services, such as, for example, a patient, a parent of a patient, a guardian of a patient, a patient's medical representative, a patient's legal representative, a custodian, and/or the like. Illustrative financial accounts include, but are not limited to, a checking account, a savings account, a credit account, a credit card account, a debit card account, a certificate of deposit, an investment account, a deposit account, a money market account, a trust account, and/or the like.

A “document” generally contains detailed information regarding a medical service provider, a patient, and/or a medical transaction. The three primary documents described herein are a statement file, a remittance, and a demographic file. However, other documents are anticipated without departing from the scope of the present disclosure. The document may be a physical file or an electronic file.

A “statement file” is generally a document, such as an electronic file, containing transaction information and/or demographic information, as described in greater detail herein. The statement file particularly relates to an interaction between a medical service provider and a patient that results in one or more services provided by the medical service provider and/or one or more payments by the patient or a third party. Illustrative interactions may include, but are not limited to, an office visit, a pharmacy visit, a hospital visit, a medical service provider's on-site medical care, emergency transportation, a mail-order pharmacy transaction, and/or the like. The statement file may be in electronic or physical form.

A “remittance” is generally a document containing transaction information, particularly evidence of a funds transfer for at least a partial payment of one or more medical services. More particularly, the remittance includes evidence of funds that have been received from a third party payor, such as, for example, an insurance provider, a health savings account, a responsible party, a government payor, an employer, and/or the like. In some embodiments, the remittance may include an actual funds transfer. In other embodiments, the remittance may be a record of the funds transfer. Similar to the statement file, the remittance can also include demographic information, as described in greater detail herein. The remittance may be in electronic or physical form.

A “demographic file” is generally a document containing demographic information, as described in greater detail herein. In some embodiments, the demographic file may include transaction information, particularly information regarding a past due amount owed by a patient.

“Transaction information” is information that generally pertains to a transaction between a medical service provider and a patient, a patient's representative, a patient's guardian, a custodian, and/or the like. Thus, the term may be used interchangeably herein with “medical transaction information”. Illustrative transaction information may include, but is not limited to, a description of various services performed by the medical service provider a medical code, a billing code, a charged amount, a contractually allowed amount, a patient responsibility amount, a name and/or contact information for any third party payor such as an insurance provider and/or the like, a payment due date, an amount past due, a premium amount, an amount due for dispensed medications and/or other personal medical devices, payment plan terms, and/or the like.

“Demographic information” is generally information regarding a patient, a patient's representative, a patient's guardian, a custodian, and/or the like. More particularly, the demographic information is information that can be parsed from a document, such as, for example, the statement file, the remittance, and/or the demographic file. For example, the document may include demographic information such as (but is not limited to) a patient name, a patient identification number (such as a social security number and/or the like), a patient's sex, a patient's age, a patient's date of birth, a patient's ethnicity, a patient's marital status, a patient's height, a patient's weight, a patient's mailing address, a patient's physical address, a patient's telephone number, a patient's email address, a patient's medical history, the medical service provider's mailing address, the medical service provider's telephone number, the medical service provider's email, the medical service provider's registration number, and/or the like.

The present disclosure relates generally to systems and methods that are configured to automatically obtain a document, parse the document for demographic information, and determine whether the patient identified in the demographic information corresponds to stored payor information having a preauthorized payment account. If the demographic information corresponds to stored payor information and an amount is due (or past due), the preauthorized payment account may automatically be charged for the amount listed in the document. Such systems and methods may alleviate issues commonly experienced by service providers in collecting payment because the payment is collected automatically without user input. In addition, service providers no longer need to conduct individual searches for each patient account to determine whether the patient has a preauthorized payment account on file. Because a service provider may have hundreds, if not thousands, of patients with an amount due, the service providers no longer have to dedicate one or more staff members or a plurality of working hours to conducting searches to determine whether each patient has a preauthorized payment account.

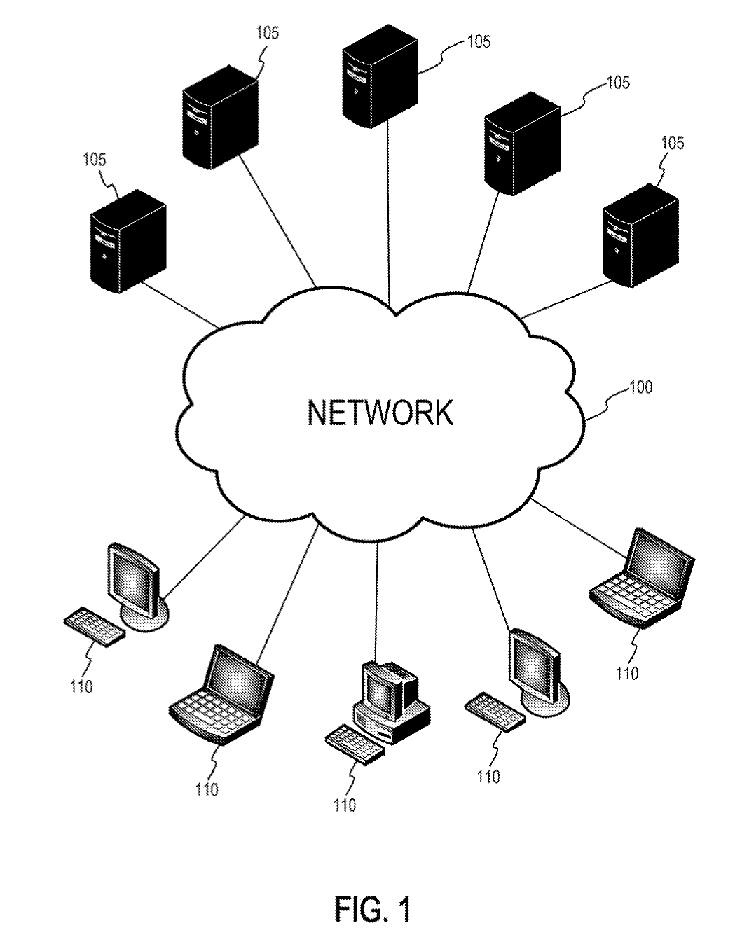

FIG. 1 depicts an illustrative diagram of a system for automatically collecting payment and/or updating demographic information according to an embodiment. The system may generally include one or more first computing devices 105 connected to one or more second computing devices 110 via a network 100. The one or more first computing devices 105 may be configured to carry out one or more processes described in greater detail herein. In some embodiments, the one or more first computing devices 105 may be one or more servers. The one or more second computing devices 110 may provide a user interface. The user interface may allow user interaction with the one or more first computing devices 105 and/or the one or more second computing devices 110. In some embodiments, the one or more second computing devices 110 may be one or more client computing devices. The network 100 may generally be any network between the one or more first computing devices 105 and the one or more second computing devices 110. For example, the network 100 may be the Internet, an intranet, a wide area network, a metropolitan area network, a local area network, an internet area network, a campus area network, a virtual private network, a personal network, and/or the like. The network 100 may include a wired network or a wireless network. Those having ordinary skill in the art will recognize various wired and wireless technologies that may be used for the network 100 without departing from the scope of the present disclosure.

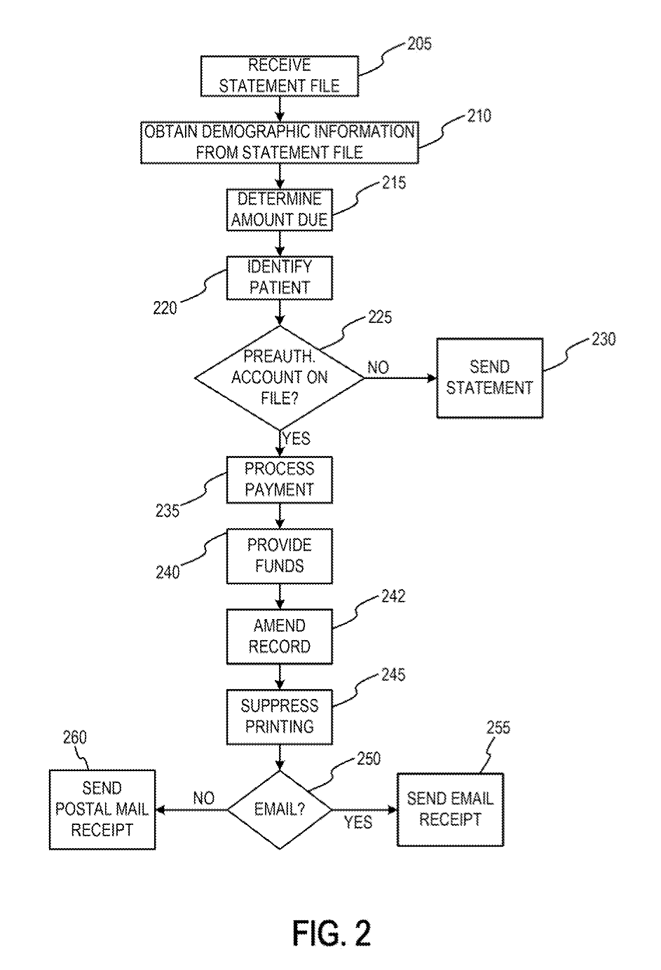

FIG. 2 depicts a flow diagram of an illustrative method of processing a payment and/or updating demographic information according to an embodiment. The method may include receiving 205 a statement file. As described in greater detail herein, the statement file may generally be a document containing information regarding a patient interaction with a healthcare provider. For example, the statement file may be a bill or the like from a healthcare provider that describes various services that were provided to the patient. The statement file may be an electronic file or may be a physical file. In some embodiments, the statement file may be received 205 from a healthcare provider, from an employee of a healthcare provider, from a representative of a healthcare provider, from a third party service provider, and/or the like. In some embodiments, the statement file may be received from a payor entity. A payor entity may generally be an entity that provides financial compensation to a healthcare provider, such as, for example, a health insurer, a government insurer, an employer, the patient, or any other entity providing the patient with financial coverage. While the statement file may generally be received 205 electronically, those having ordinary skill in the art will recognize that the statement file may also be received via other methods, such as via facsimile, postal mail, hand delivery, and/or the like without departing from the scope of the present disclosure. In embodiments where the statement file is not received electronically, it may be transformed to an electronic format.

Demographic information may be obtained 210 from the statement file. In some embodiments, the demographic information may be obtained 210 by parsing, scanning, and/or reading the statement file and extracting demographic information from the statement file. For example, the statement file may be parsed with an optical character recognition (OCR) module and/or the like to obtain 210 demographic information therefrom. In some embodiments, the demographic information may be mapped to one or more particular fields within the statement file, and the demographic information may be obtained 210 by pulling the information from the mapped fields. While the demographic information may generally be obtained 210 automatically, such as by a computing device, those with ordinary skill in the art will recognize that manual entry may occasionally be necessary or desired to obtain the demographic information. For example, the demographic information may be illegible or incorrectly read by the OCR module and may have to be verified and/or corrected via manual entry.

In addition to obtaining 210 demographic information, an amount due may be determined 215. In some embodiments, the amount due may generally be determined 215 in a manner similar to obtaining 210 the demographic information. Thus, the amount due may be determined 215 by scanning and/or reading the statement file and extracting the amount due therefrom. For example, the amount due may be determined 215 by using an OCR module and/or the like. In some embodiments, the amount due may be mapped to one or more particular fields within the statement file, and the amount due may be determined 215 by pulling the information from the mapped fields. While the method of determining 215 the amount due may generally be completed automatically, such as by a computing device, those with ordinary skill in the art will recognize that manual entry may occasionally be necessary or desired to obtain the amount due. For example, the amount due may be illegible or incorrectly read by the OCR module and may have to be verified and/or corrected via manual entry. In some embodiments, the amount due may be determined 215 by calculating the amount due from various other amounts that may be provided in the statement file. For example, determining 215 the amount due may include obtaining a total amount charged, determining an allowable amount, deducting an amount paid by a third party, and/or the like. In some embodiments, determining 215 the amount due may be completed at substantially the same time as obtaining 210 demographic information.

In various embodiments, a patient may be identified 220 from the demographic information, and a determination 225 may be made as to whether the identified patient has previously provided a preauthorized payment account. For example, the patient may have previously provided the preauthorized payment account during a registration process, after previously receiving services, and/or the like. When providing a preauthorized payment account, the patient may generally provide information pertinent to the account, such as, for example, an account number, a routing/transit number, an expiration date, a card verification value (CVV) number, a card validation code (CVC), a card identification number (CID), a card security code (CSC), the authorized name on the account, the address associated with the account, an account PIN, an account password, an authorized user identifier (for example, the last 4 digits of a social security number), and/or the like. In addition, the patient may authorize an amount to be deducted from or charged to the account each time payment is due. This authorization may be for any amount, for a fixed amount, a capped amount, and/or the like. In some embodiments, the authorization may be for a particular period of time (for example, permission to charge an account for any charges accrued in the next two years).

In some embodiments, the determination 225 may also include determining whether the preauthorized payment account is currently active. For example, in instances where the preauthorized payment account is a credit card with an expiration date, the determination 225 may verify that the credit card has not expired. In another example, the determination 225 may include verifying that the preauthorized payment account is still open. In yet another example, the determination 225 may include verifying that the preauthorized payment account contains sufficient funds for payment. In any of these examples, if payment cannot be made for some reason (for example, if the credit card has expired, the account is closed, or insufficient funds are available), the patient may be sent 230 a statement (as described herein) requesting that the preauthorized payment account be updated.

If the patient has not previously provided a preauthorized payment account, a statement may be sent 230 to the patient. The statement may generally include an amount for which the patient is responsible, as well as information regarding where the payment may be sent. In some embodiments, the statement may include an option to enroll a preauthorized payment account to avoid receiving statements in the future. For example, the option to enroll a preauthorized payment account may include requests for information such as an account type, a financial institution name, an account number, a routing/transit number, an account holder name, an expiration date, a CVV number, a CVC, a CID, a CSC, a PIN, a billing address, an authorized signature, an amount authorized to be charged, and/or the like. In addition to sending 230 a statement, a record containing the demographic information may be updated to reflect the demographic information obtained 210 from the statement file. Such an update may ensure that the patient's current demographic information is up-to-date.

If the patient has previously provided a preauthorized payment account, the payment may be processed 235. The payment may generally be processed 235 by deducting an amount from the preauthorized payment account that corresponds to the previously-determined amount due. For example, the amount due may be charged to a credit card, transferred via an electronic funds transfer (EFT), transferred via an electronic benefit transfer (EBT), transferred via a wire transfer, processed via an automated clearing house (ACH) transaction, and/or the like.

In various embodiments, the payment that was processed 235 may be provided 240 to a payee. In some embodiments, providing 240 the payment may include adding the deducted amount from the preauthorized payment account to a payee account. In some embodiments, the payee account may be an account associated with the medical service provider. For example, the payee account may be the medical service provider's bank account. In another example, the payee account may be an account owned and/or controlled by a third party, such as, for example, a party authorized by the medical service provider to receive, send, and/or manage funds on behalf of the medical service provider.

A record may be amended 242 or created to indicate that the payment has been processed 235. Such a record may be amended 242 or created to ensure that a patient is not subsequently charged for the amount due. The record may further be amended 242 or created to ensure that any out-of-date demographic information is updated to reflect the obtained 210 demographic information. The record is not limited by this disclosure, and may generally be any record. In some embodiments, the record may be a stored patient file, such as, for example, a stored patient file containing the preauthorized payment account. In some embodiments, the record may be a posting file.

Occasionally, systems may be configured to automatically print and/or send a statement to a patient and/or a responsible party if funds are due. To avoid unnecessary statement printing and/or sending, the printing may be suppressed 245. For example, in some embodiments, a statement printer may be directed to suppress statement printing. This may be completed, for example, by sending a suppress signal to the statement printer. Suppressing 245 printing may also include suppressing the transmission of a statement to a patient and/or a responsible party, particularly in instances where statements are sent electronically and no printing occurs.

In some embodiments, a determination 250 may be made as to whether one or more parties has a registered email address. For example, the determination 250 may include determining whether the patient has a registered email address. A registered email address may generally be an email address that a party has provided and authorized for sending of receipts and/or other information. If a registered email address exists, a receipt may be sent 255 to the party via email. If a registered email address does not exist, a receipt may be sent 260 via an alternative method, such as, for example, via a physical delivery service.

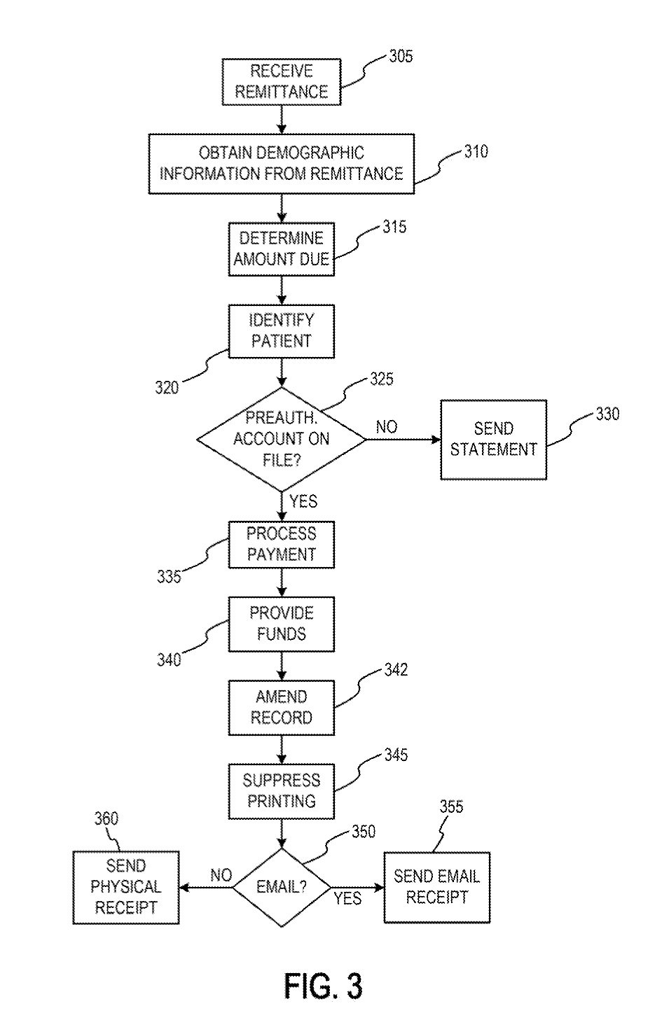

FIG. 3 depicts a flow diagram of an illustrative method of processing a remittance according to an embodiment. The method may include receiving 305 the remittance. In some embodiments, the remittance may be received 305 from a payor entity, a healthcare provider, an employee of a healthcare provider, a representative of a healthcare provider, a third party service provider, and/or the like. While the remittance may generally be received 305 electronically, those having ordinary skill in the art will recognize that the remittance may also be received via other methods, such as via facsimile, postal mail, hand delivery, and/or the like without departing from the scope of the present disclosure. In embodiments where the remittance is not received electronically, it may be transformed into an electronic format.

Demographic information may be obtained 310 from the remittance. In some embodiments, the demographic information may be obtained 310 by parsing, scanning, and/or reading the remittance and extracting demographic information therefrom. For example, the remittance may be parsed with an OCR module and/or the like to obtain 310 demographic information therefrom. In some embodiments, the demographic information may be mapped to one or more particular fields within the remittance, and the demographic information may be obtained 310 by pulling the information from the mapped fields. While the demographic information may generally be obtained 310 automatically, such as by a computing device, those with ordinary skill in the art will recognize that manual entry may occasionally be necessary or desired to obtain the demographic information. For example, the demographic information may be illegible or incorrectly read by the OCR module and may have to be verified and/or corrected via manual entry.

In addition to obtaining 310 demographic information, an amount due may be determined 315. In some embodiments, the amount due may generally be determined 315 in a manner similar to obtaining 310 the demographic information. Thus, the amount due may be determined 315 by scanning and/or reading the remittance and extracting the amount due therefrom. For example, the amount due may be determined 315 by using an OCR module and/or the like. In some embodiments, the amount due may be mapped to one or more particular fields within the remittance, and the amount due may be determined 315 by pulling the information from the mapped fields. While the method of determining 315 the amount due may generally be completed automatically, such as by a computing device, those with ordinary skill in the art will recognize that manual entry may occasionally be necessary or desired to obtain the amount due. For example, the amount due may be illegible or incorrectly read by the OCR module and may have to be verified and/or corrected via manual entry. In some embodiments, the amount due may be determined 315 by calculating the amount due from various other amounts that may be provided in the remittance. For example, determining 315 the amount due may include obtaining a total amount charged, determining an allowable amount, deducting an amount indicated as paid by the remittance, and/or the like. In some embodiments, determining 315 the amount due may be completed at substantially the same time as obtaining 310 demographic information.

In various embodiments, a patient may be identified 320 from the demographic information, and a determination 325 may be made as to whether the identified patient has previously provided a preauthorized payment account. For example, the patient may have previously provided the preauthorized payment account during a registration process, after previously receiving services, and/or the like. When providing a preauthorized payment account, the patient may generally provide information pertinent to the account, such as, for example, an account number, a routing/transit number, an expiration date, a CVV number, a CVC, a CID, a CSC, the authorized name on the account, the address associated with the account, an account PIN, an account password, an authorized user identifier (for example, the last 4 digits of a social security number), and/or the like. In addition, the patient may authorize an amount to be deducted from or charged to the account each time payment is due. This authorization may be for any amount, for a fixed amount, a capped amount, and/or the like. In some embodiments, the authorization may be for a particular period of time (for example, permission to charge an account for any charges accrued in the next two years).

In some embodiments, the determination 325 may also include determining whether the preauthorized payment account is currently active. For example, in instances where the preauthorized payment account is a credit card with an expiration date, the determination 325 may verify that the credit card has not expired. In another example, the determination 325 may include verifying that the preauthorized payment account is still open. In yet another example, the determination 325 may include verifying that the preauthorized payment account contains sufficient funds for payment. In any of these examples, if payment cannot be made for some reason (for example, if the credit card has expired, the account is closed, or insufficient funds are available), the patient may be sent 330 a statement (as described herein) requesting that the preauthorized payment account be updated.

If the patient has not previously provided a preauthorized payment account, a statement may be sent 330 to the patient. The statement may generally include an amount for which the patient is responsible, as well as information regarding where the payment may be sent. In some embodiments, the statement may include an option to enroll a preauthorized payment account to avoid receiving statements in the future. For example, the option to enroll a preauthorized payment account may include requests for information such as an account type, a financial institution name, an account number, a routing/transit number, an account holder name, an expiration date, a CVV number, a CVC, a CID, a CSC, a PIN, a billing address, an authorized signature, an amount authorized to be charged, and/or the like. In addition to sending 330 a statement, a record containing the demographic information may be updated to reflect the demographic information obtained 310 from the statement file. Such an update may ensure that the patient's current demographic information is up-to-date.

If the patient has previously provided a preauthorized payment account, the payment may be processed 335. The payment may generally be processed 335 by deducting an amount from the preauthorized payment account that corresponds to the previously-determined amount due. For example, the amount due may be charged to a credit card, transferred via EFT, transferred via EBT, transferred via a wire transfer, processed via an ACH transaction, and/or the like.

In various embodiments, the payment that was processed 335 may be provided 340 to a payee. In some embodiments, providing 340 the payment may include adding the deducted amount from the preauthorized payment account to a payee account. In some embodiments, the payee account may be an account associated with the medical service provider. For example, the payee account may be the medical service provider's bank account. In another example, the payee account may be an account owned and/or controlled by a third party, such as, for example, a party authorized by the medical service provider to receive, send, and/or manage funds on behalf of the medical service provider.

A record may be amended 342 or created to indicate that the payment has been processed 335. Such a record may be amended 342 or created to ensure that a patient is not subsequently charged for the amount due. The record may further be amended 342 or created to ensure that any out-of-date demographic information is updated to reflect the obtained 310 demographic information. The record is not limited by this disclosure, and may generally be any record. In some embodiments, the record may be a stored patient file, such as, for example, a stored patient file containing the preauthorized payment account. In some embodiments, the record may be a posting file.

Occasionally, systems may be configured to automatically print and/or send a statement to a patient and/or a responsible party if funds are due. To avoid unnecessary statement printing and/or sending, the printing may be suppressed 345. For example, in some embodiments, a statement printer may be directed to suppress statement printing. This may be completed, for example, by sending a suppress signal to the statement printer. Suppressing 345 printing may also include suppressing the transmission of a statement to a patient and/or a responsible party, particularly in instances where statements are sent electronically and no printing occurs.

In some embodiments, a determination 350 may be made as to whether one or more parties has a registered email address. For example, the determination 350 may include determining whether the patient has a registered email address. A registered email address may generally be an email address that a party has provided and authorized for sending of receipts and/or other information. If a registered email address exists, a receipt may be sent 355 to the party via email. If a registered email address does not exist, a receipt may be sent 360 via an alternative method, such as, for example, via a physical delivery service.

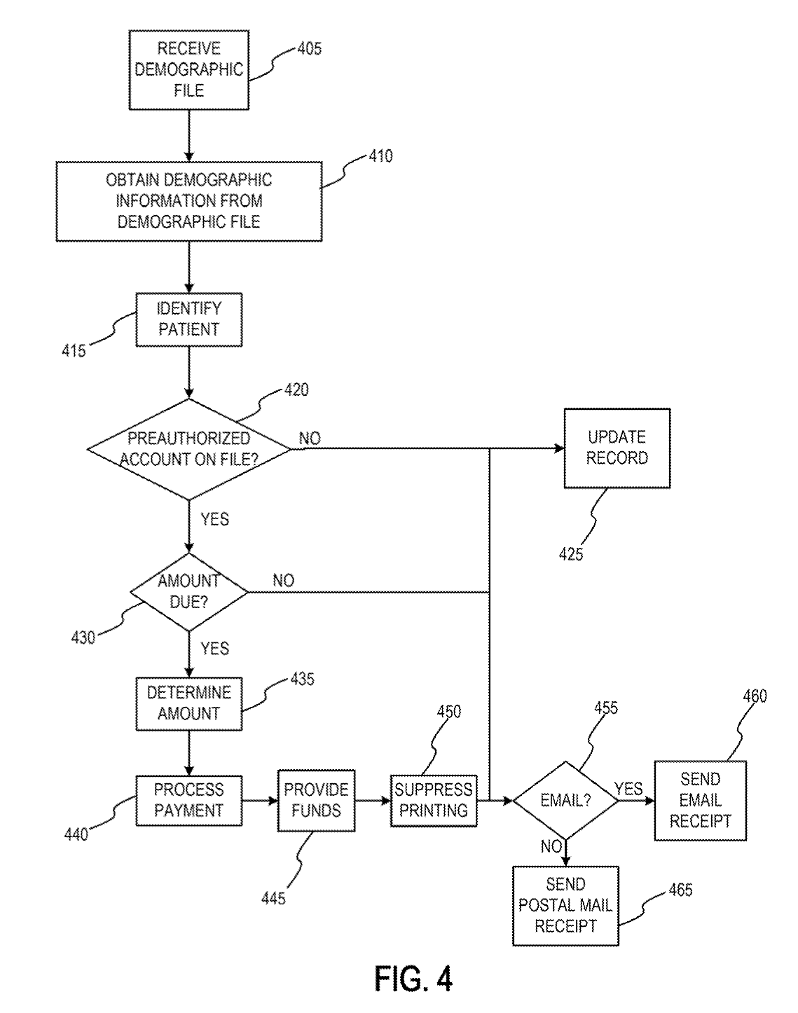

FIG. 4 depicts a flow diagram of an illustrative method of processing a demographic file according to an embodiment. The method may include receiving 405 the demographic file. As used herein, the demographic file may generally contain demographic information about a patient, including demographic information previously described herein. In some embodiments, the demographic file may include an amount that is past due, such as an amount that has not previously been paid. Similar to the statement file, the demographic file may also include information regarding a patient interaction with a healthcare provider. For example, the demographic file may include a description of various historical services that were provided to the patient by a healthcare provider. The demographic file may be in electronic or physical form. In some embodiments, the demographic file may be received 405 from a healthcare provider, an employee of a healthcare provider, a representative of a healthcare provider, a third party service provider, a payor entity, and/or the like. In some embodiments, receiving 405 may include receiving a request to update a demographic file. While the demographic file may generally be received 405 electronically, those having ordinary skill in the art will recognize that the demographic file may also be received via other methods, such as via facsimile, postal mail, hand delivery, and/or the like without departing from the scope of the present disclosure. In embodiments where the demographic file is not received electronically, it may be transformed into an electronic format.

Demographic information may be obtained 410 from the demographic file. In some embodiments, the demographic information may be obtained 410 by parsing, scanning, and/or reading the demographic file and extracting demographic information therefrom. For example, the demographic file may be parsed with an OCR module and/or the like to obtain 410 the demographic information therefrom. In some embodiments, the demographic information may be mapped to one or more particular fields within the demographic file, and the demographic information may be obtained 410 by pulling the information from the mapped fields. While the demographic information may generally be obtained 410 automatically, such as by a computing device, those with ordinary skill in the art will recognize that manual entry may occasionally be necessary or desired to obtain the demographic information. For example, the demographic information may be illegible or incorrectly read by the OCR module and may have to be verified and/or corrected via manual entry.

In various embodiments, a patient may be identified 415 from the demographic information, and a determination 420 may be made as to whether the identified patient has previously provided a preauthorized payment account. For example, the patient may have previously provided the preauthorized payment account during a registration process, after previously receiving services, and/or the like. When providing a preauthorized payment account, the patient may generally provide information pertinent to the account, such as, for example, an account number, a routing/transit number, an expiration date, a CVV number, a CVC, a CID, a CSC, the authorized name on the account, the address associated with the account, an account PIN, an account password, an authorized user identifier (for example, the last 4 digits of a social security number), and/or the like. In addition, the patient may agree to allow an amount to be deducted from or charged to the account each time payment is due. This agreement may be for any amount, for a fixed amount, a capped amount, and/or the like. In some embodiments, the agreement may be for a particular period of time (for example, permission to charge an account for any charges accrued in the next two years).

In some embodiments, the determination 420 may also include determining whether the preauthorized payment account is currently active. For example, in instances where the preauthorized payment account is a credit card with an expiration date, the determination 420 may verify that the credit card has not expired. In another example, the determination 420 may include verifying that the preauthorized payment account is still open. In yet another example, the determination 420 may include verifying that the preauthorized payment account contains sufficient funds for payment.

If the patient has not previously provided a preauthorized payment account, a record may be updated 425 with any demographic information from the obtained demographic file that is inconsistent with information found in the record. For example, if the demographic information indicates that the patient has a new mailing address, the record may be updated 425 accordingly to reflect the new mailing address.

If the patient has previously provided a preauthorized payment account, a determination 430 may be made as to whether a past due amount exists. If a past due amount does not exist, the record may be updated 425 with any demographic information from the obtained demographic file that is inconsistent with information found in the demographic record, as previously described herein. If a past due amount does exist, the actual amount that is due may be determined 435. The past due amount may generally be determined 435 in a manner similar to obtaining 410 the demographic information. Thus, the past due amount may be determined by scanning and/or reading the demographic file and extracting the past due amount therefrom. For example, the past due amount may be determined 435 by using an OCR module and/or the like. In some embodiments, the past due amount may be mapped to one or more particular fields within the demographic file, and the past due amount may be determined 435 by pulling the information from the mapped fields. While the method of determining 435 the past due amount may generally be completed automatically, such as by a computing device, those with ordinary skill in the art will recognize that manual entry may occasionally be necessary or desired to obtain the amount due. For example, the past due amount may be illegible or incorrectly read by the OCR module and may have to be verified and/or corrected via manual entry.

Once the amount due is determined 435, payment for the past due amount may be processed 440. The payment may generally be processed 440 by deducting an amount from the preauthorized payment account that corresponds to the previously-determined past due amount. For example, the past due amount may be charged to a credit card, transferred via EFT, transferred via EBT, transferred via a wire transfer, processed via an ACH transaction, and/or the like.

In various embodiments, the payment that was processed 440 may be provided 445 to a payee. In some embodiments, providing 445 the payment may include adding the deducted amount from the preauthorized payment account to a payee account. In some embodiments, the payee account may be an account associated with the medical service provider. For example, the payee account may be the medical service provider's bank account. In another example, the payee account may be an account owned and/or controlled by a third party, such as, for example, a party authorized by the medical service provider to receive, send, and/or manage funds on behalf of the medical service provider.

Occasionally, systems may be configured to automatically print and/or send a statement to a patient and/or a responsible party if funds are past due. To avoid unnecessary statement printing and/or sending, the printing may be suppressed 450. For example, in some embodiments, a statement printer may be directed to suppress statement printing. This may be completed, for example, by sending a suppress signal to the statement printer. Suppressing 450 printing may also include suppressing the transmission of a statement to a patient and/or a responsible party, particularly in instances where statements are sent electronically and no printing occurs.

In various embodiments, the record may be updated 425 to reflect that the past due amount has been paid. In some embodiments, in addition to updating 425 the record, a determination 455 may be made as to whether one or more parties has a registered email address. For example, the determination 455 may include determining whether the patient has a registered email address. A registered email address may generally be an email address that a party has provided and authorized for sending of receipts and/or other information. If a registered email address exists, a receipt may be sent 460 to the party via email. If a registered email address does not exist, a receipt may be sent 465 via an alternative method, such as, for example, via a physical delivery service.

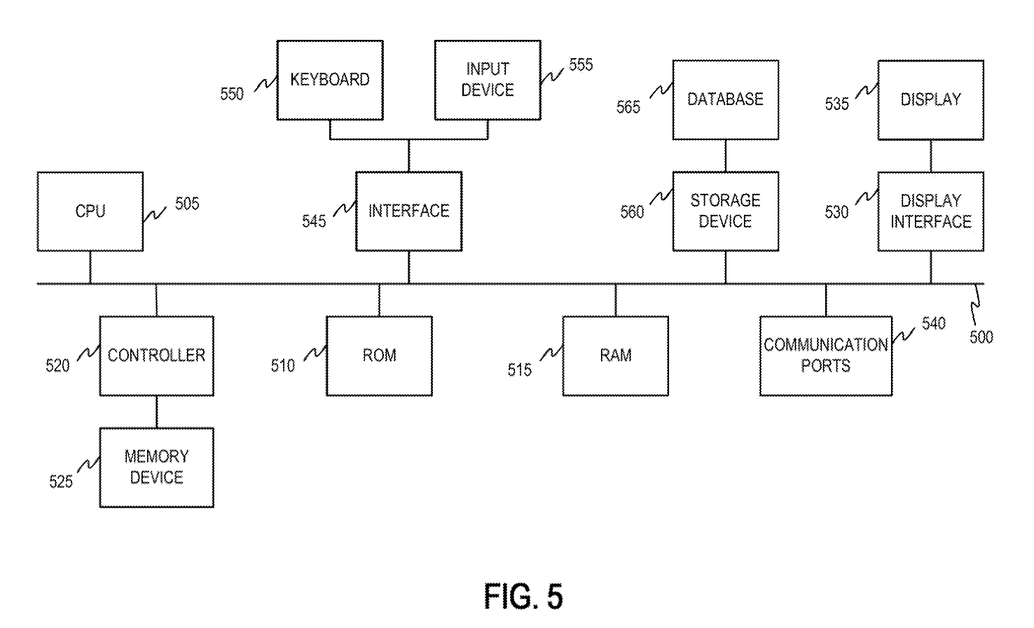

FIG. 5 depicts a block diagram of illustrative internal hardware that may be used to contain or implement program instructions, such as the process steps discussed herein, according to various embodiments. A bus 500 may serve as the main information highway interconnecting the other illustrated components of the hardware. A CPU 505 is the central processing unit of the system, performing calculations and logic operations required to execute a program. The CPU 505, alone or in conjunction with one or more of the other elements disclosed in FIG. 5, is an illustrative processing device, computing device or processor as such terms are used within this disclosure. Read only memory (ROM) 510 and random access memory (RAM) 515 constitute illustrative memory devices (such as, for example, processor-readable non-transitory storage media).

A controller 520 interfaces with one or more optional memory devices 525 to the system bus 500. These memory devices 525 may include, for example, an external or internal DVD drive, a CD ROM drive, a hard drive, flash memory, a USB drive, or the like. As indicated previously, these various drives and controllers are optional devices.

Program instructions, software, or interactive modules for providing the interface and performing any querying or analysis associated with one or more data sets may be stored in the ROM 510 and/or the RAM 515. Optionally, the program instructions may be stored on a tangible computer-readable medium such as a compact disk, a digital disk, flash memory, a memory card, a USB drive, an optical disc storage medium, such as a Blu-ray™ disc, and/or other non-transitory storage media.

An optional display interface 530 may permit information from the bus 500 to be displayed on the display 535 in audio, visual, graphic, or alphanumeric format, such as the interface previously described herein. Communication with external devices, such as a print device, may occur using various communication ports 540. An illustrative communication port 540 may be attached to a communications network, such as the Internet, an intranet, or the like.

The hardware may also include an interface 545 which allows for receipt of data from input devices such as a keyboard 550 or other input device 555 such as a mouse, a joystick, a touch screen, a remote control, a pointing device, a video input device and/or an audio input device.

The hardware may also include a storage device 560 such as, for example, a connected storage device, a server, and an offsite remote storage device. Illustrative offsite remote storage devices may include hard disk drives, optical drives, tape drives, cloud storage drives, and/or the like. The storage device 560 may be configured to store data as described herein, which may optionally be stored on a database 565. The database 565 may be configured to store information in such a manner that it can be indexed and searched, as described herein.

The computing device of FIG. 5 and/or components thereof may be used to carry out the various processes as described herein.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A system comprising:
a processor; and
a non-transitory, processor-readable storage medium, wherein the non-transitory, processor-readable storage medium comprises one or more programming instructions that, when executed, cause the processor to:
receive a document comprising medical transaction information and demographic information from a medical service provider;
parse the document to obtain the demographic information;
determine that the demographic information corresponds to a stored patient account having a preauthorized payment account; and
deduct an amount from the preauthorized payment account that corresponds to at least a portion of an amount due obtained from the medical transaction information.

2. The system of claim 1, wherein the document is a statement file, a remittance, or a demographic file.

3. The system of claim 1, wherein the non-transitory, processor-readable storage medium further comprises one or more programming instructions that, when executed, cause the processor to credit the amount due to a medical service provider account.

4. The system of claim 1, wherein the non-transitory, processor-readable storage medium further comprises one or more programming instructions that, when executed, cause the processor to edit a record to include evidence of the deducted amount.

5. The system of claim 1, wherein the non-transitory, processor-readable storage medium further comprises one or more programming instructions that, when executed, cause the processor to direct a statement printer to suppress printing of a statement.

6. The system of claim 1, wherein the non-transitory, processor-readable storage medium further comprises one or more programming instructions that, when executed, cause the processor to send a receipt to a payor.

7. The system of claim 1, wherein the portion of the amount due corresponds to a patient responsibility amount.

8. The system of claim 1, wherein the non-transitory, processor-readable storage medium further comprises one or more programming instructions that, when executed, cause the processor to send a payment request to one or more third party payor entities, wherein the payment request comprises a second portion of the amount due.

9. The system of claim 1, wherein the non-transitory, processor-readable storage medium further comprises one or more programming instructions that, when executed, cause the processor to edit information in the stored patient account to correspond to the demographic information.

10. A method comprising:
receiving, by a processor, a document comprising medical transaction information and demographic information from a medical service provider;
parsing, by the processor, the document to obtain the demographic information;
determining, by the processor, that the demographic information corresponds to a stored patient account having a preauthorized payment account; and
deducting, by the processor, an amount from the preauthorized payment account that corresponds to at least a portion of an amount due obtained from the medical transaction information.

11. The method of claim 10, wherein the document is a statement file, a remittance, or a demographic file.

12. The method of claim 10, further comprising crediting, by the processor, the amount due to a medical service provider account.

13. The method of claim 10, further comprising editing, by the processor, a record to include evidence of the deducted amount.

14. The method of claim 10, further comprising directing, by the processor, a statement printer to suppress printing of a statement.

15. The method of claim 10, further comprising sending, by the processor, a receipt to a payor.

16. The method of claim 10, wherein the portion of the amount due corresponds to a patient responsibility amount.

17. The method of claim 10, further comprising sending, by the processor, a payment request to one or more third party payor entities, wherein the payment request comprises a second portion of the amount due.

18. The method of claim 10, further comprising editing, by the processor, information in the stored patient account to correspond to the demographic information.

19. A system comprising:
a processor; and
a non-transitory, processor-readable storage medium, wherein the non-transitory, processor-readable storage medium comprises one or more programming instructions that, when executed, cause the processor to:
receive a document comprising medical transaction information and demographic information from a medical service provider;
parse the document to obtain the demographic information;
determine that the demographic information corresponds to a stored patient account not having a preauthorized payment account; and
cause a statement to be sent to a payor associated with the stored patient account, wherein the statement comprises an amount that corresponds to at least a portion of an amount due obtained from the medical transaction information.

20. The system of claim 19, wherein the non-transitory, processor-readable storage medium further comprises one or more programming instructions that, when executed, cause the processor to edit information in the stored patient account to correspond to the demographic information.
